(19) United States
(12) Patent Application Publication
(10) Pub. No.: US 2007/0101278 A1
(43) Pub. Date: May 3, 2007

(54) Web site theme designer

(75) Inventors: Andrew Ryan Pickering, Woodinville, WA (US); Eric Alan Smith, Bonney Lake, WA (US); Ravikumar Bangalore Gopinath, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/263,460

(22) Filed: Oct. 31, 2005

(51) Int. Cl. G06F 17/30

(52) U.S. Cl. 715/762; 707/10

(57) ABSTRACT

A user interface for a user interface creation software service is provided. The user interface includes a first display portion corresponding to a display of user interface data management categories such as theme, footer management, header management, font style and navigation style. The user interface includes a second display portion corresponding to a selected user interface data management category that is dynamically adjusted dependent on the selected user interface data management category. Selection of a data management category is applied to all user interface components.

### BACKGROUND

Generally described, network-based computing environments provide an opportunity for users to access software services from a receiving computing device. In a typical operating environment, a receiving computing device can utilize a browser software application, to access software services remotely hosted on a communication network, such as the Internet. For example, a receiving computing device can utilize a browser software application to access a Web site user interface, or software application user interface, software service remotely hosted by a sending computing device, such as a server computer.

In a typical embodiment, the receiving computing devices implement network-based software services by generating a software service specific user interface within the display portion of the browser software application. In such embodiments, the user is presented with various graphical controls corresponding to the browser software application and additional graphical controls corresponding to the software service specific user interface. As software services grow in popularity and complexity, the number of graphical controls presented on a user display can be confusing, especially to users accessing the specific network-based software service for the first time. With regard specifically to network-based user interface software services, current user interface approaches are inefficient in providing non-skilled users the ability to select various controls and implement desired user interface creation and/or management functionality.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A user interface for a user interface creation software service is provided. The user interface includes a first display portion corresponding to a display of user interface data management categories such as theme, footer management, header management, font style and navigation style. The user interface includes a second display portion corresponding to a selected user interface data management category that is dynamically adjusted dependent on the selected user interface data management category. Selection of a data management category is applied to all user interface components.

In accordance with an aspect of the invention, a method for generating a user interface is provided. The method can be implemented in a communication network including at least one sending computing device and a receiving computing device. The receiving computing device requests data from the sending computing device corresponding to a software service. Based upon code returned form the sending computing device, the receiving computing device then generates a user interface corresponding to the software service on a display.

In accordance with the method, the receiving computing device generates in a first display portion of the user interface creation software service a display of a set of user interface data management categories. At least one of the user interface data management categories corresponds to a theme associated with the user interface. The receiving computing device then obtains a selection of at least one user interface data management category. Based upon the selection of the user interface data management category, the receiving computing device dynamically generates in a second display portion of the user interface creation software service a display of at least one control associated with the selected user interface data management category. The second display portion of the user interface creation includes the controls associated with the selected user interface data management category displayed as adjacent controls. In other embodiments, the receiving computing device obtains a selection of a control in the second display portion of the user interface creation software service. The receiving computing device can then modify at least one user interface component based upon a selection of the control in the second display portion

In accordance with an aspect of the invention, a computer-readable medium having computer-executable components for generating a user interface is provided. The computer-executable components can be implemented in a communication network including at least one sending computing device and a receiving computing device. The receiving computing device requests data from the sending computing device corresponding to a software service. Based upon code returned form the sending computing device, the receiving computing device then generates a user interface corresponding to the software service on a display.

The computer-executable components include a user interface data management category component for displaying a set of user interface data management categories. The user interface data management components include at least one user interface data management category corresponding to a theme associated with the user interface. The computer-executable components also include a user interface control component that includes at least one control associated with the selected user interface data management category.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an illustrative operating environment in accordance with an aspect of the present invention;

FIG. 2 is a block diagram of the operating environment of FIG. 1 illustrating the selection of controls associated with a theme user interface data management category in accordance with an aspect of the present invention;

FIG. 3 is a block diagram of the operating environment of FIG. 1 illustrating the selection of controls associated with user interface data management categories in accordance with an aspect of the present invention;

FIG. 4 is a block diagram of a user interface including a first display portion corresponding to a set of user interface data management categories and a second display portion corresponding to a set of user interface data management controls in accordance with an aspect of the present invention;

FIG. 5 is a block diagram of the user interface of FIG. 4 illustrating a selected theme user interface data management category and various user interface data management controls associated with the selected user interface data management category in accordance with an aspect of the present invention;

FIG. 6 is a block diagram of the user interface of FIG. 4 illustrating a selected header management user interface data management category and various user interface data management controls associated with the selected user interface data management category in accordance with an aspect of the present invention;

FIG. 7 is a block diagram of the user interface of FIG. 4 illustrating a selected font style user interface data management category and various user interface data management controls associated with the selected user interface data management category in accordance with an aspect of the present invention;

FIG. 8 is a block diagram of the user interface of FIG. 4 illustrating a selected navigation style user interface data management category and various user interface data management controls associated with the selected user interface data management category in accordance with an aspect of the present invention;

FIG. 9 is a block diagram of the user interface of FIG. 4 illustrating a selected footer management user interface data management category and various user interface data management controls associated with the selected user interface data management category in accordance with an aspect of the present invention; and

FIG. 10 is a block diagram of the user interface of FIG. 4 illustrating a selected an advanced user interface data management category and various user interface data management controls associated with the selected user interface data management category in accordance with an aspect of the present invention.

### DETAILED DESCRIPTION

Generally described, the present invention relates to a user interface for the creation and/or management of user interface. More specifically, the present invention relates to a user information user interface utilized in conjunction with network-based software service for creating and/or managing user interfaces. Although the present invention will be described with relation to illustrative user interfaces and operating environments, one skilled in the relevant art will appreciate that the disclosed embodiments are illustrative in nature and should not be construed as limiting.

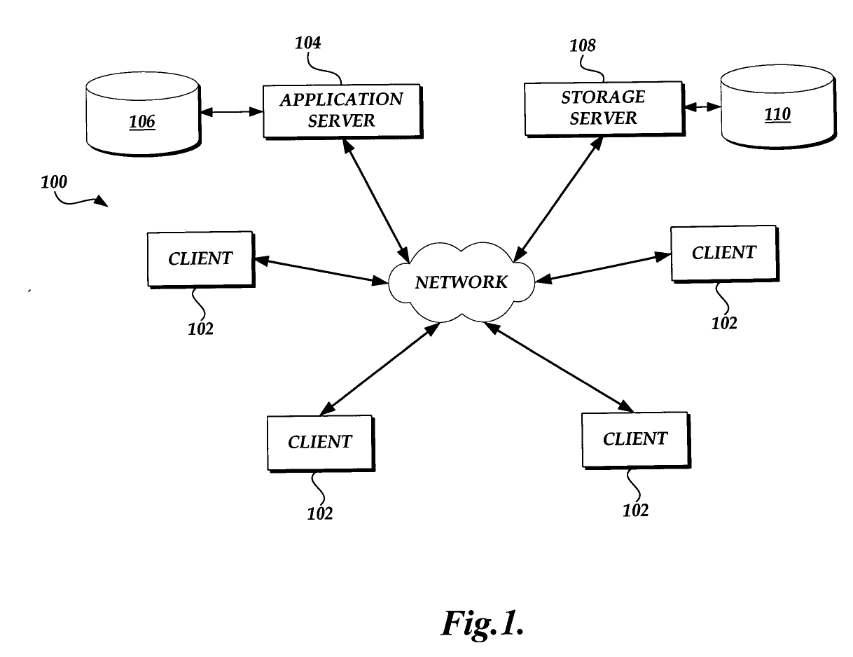

With reference now to FIG. 1, an illustrative operating environment 100 includes a plurality of receiving computing devices, such as client computing devices 102, that can communicate via a communication network, such as the Internet or an intranet. In an illustrative embodiment, the client computing devices 102 can include a software application, such as a browser software application to facilitate communication via the network. The operating environment also includes one or more sending computing devices, such as an application server 104 and storage server 108, that communicate with the client computing devices 102. The application servers 104 include storage 106 for storing information associated with the creation or management of user interfaces, such as pre-computed theme combinations. The storage servers 108 also include storage 110 for storing information associated with specific user interface component information selected by a client computing device 102. Although the application servers 104 and storage servers 108 are illustrated as separate computing devices, one skilled in the relevant art will appreciate that the application server and storage server may be a single computing device. Further, storage 106, 110 may correspond to local storage or distributed storage via the communication network. Additionally, one skilled in the relevant art will appreciate that the client computing device 102 and/or application servers 104 can correspond to a variety of computing devices such as personal computers, hand-held computers, mobile computers, mobile telephones, server computers, and the like.

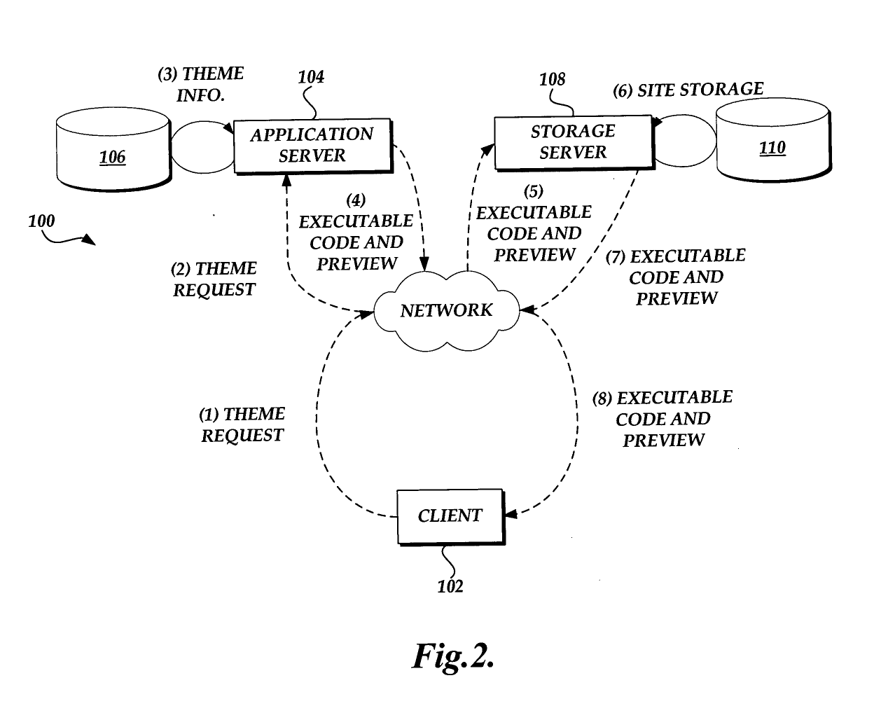

With reference to FIG. 2, in an illustrative embodiment, the client computing devices 102 can generate a request for a theme creation or theme modification. The request is transmitted via the communication network to the application server 104. The application server 104 transmits theme information from the storage 106 to the storage server 108, which stores user selections in storage 110. In an illustrative embodiment, the theme combination information is pre-computed for all possible combination of theme controls. Alternatively, the application server may generate appropriate information according to the client computing device request. The storage server 108 then transmits code to generate the selected user interface components on the client computing device to the client computing device 102. In an illustrative embodiment, the selection of a user interface data management control corresponding to the theme user interface data management category is applied to each component of the user interface. For example, in the context of a Web site creation application, selection of a theme user interface data management control would result in the theme control being applied to all existing and new Web pages.

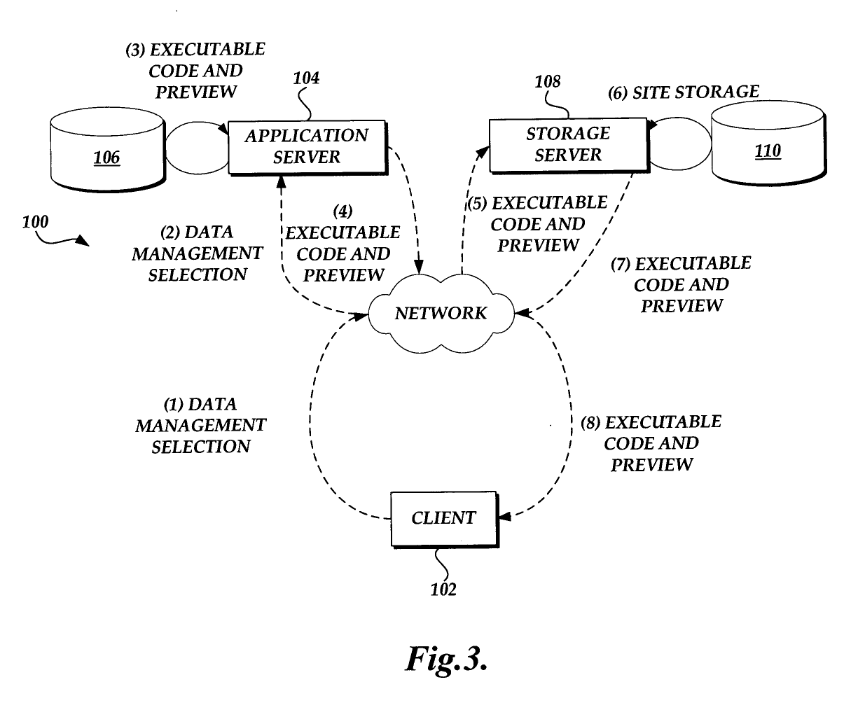

With reference to FIG. 3, in a more general embodiment, the client computing devices 102 can generate a request for a control associated with any user interface data management category. The application server 104 transmits code to generate the selected user interface components on the client computing device to the storage server 108, which stores user selections in storage 110. The storage server 108 then transmits code to generate the selected user interface components on the client computing device to the client computing device 102. As described above with regard to theme categories, in an illustrative embodiment, the selection of a user interface data management control corresponding to the other user interface data management categories is applied to each component of the user interface. For example, in the context of a Web site creation application, selection of any data management control would result in the theme control being applied to all existing and new Web pages.

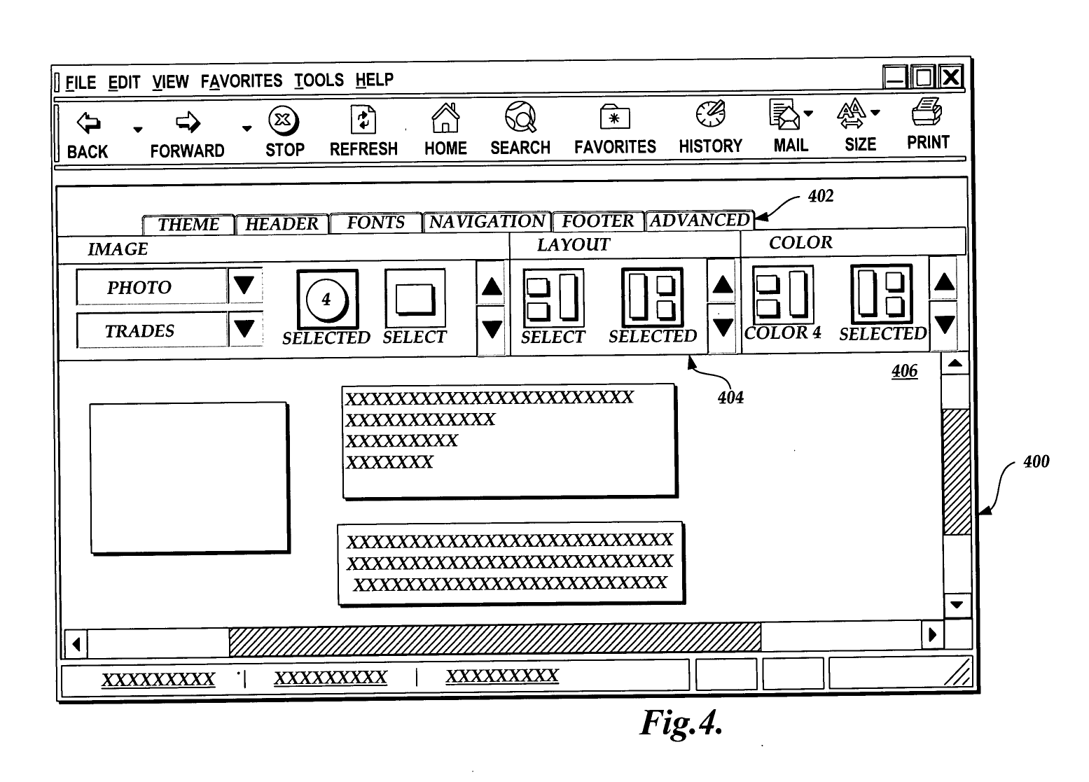

With reference now to FIGS. 4, an illustrative user interface 400 for creation and/or management of user interfaces will be described. The user interface 400 includes a first display portion 402 for displaying a set of user interface data management categories including theme management, header management, font style, navigation style, footer management and advanced management. The user interface 400 also includes a second display portion for displaying as et of user interface data management controls associated with a selected user interface data management category and automatically displayed based upon the selected user interface data management category. The user interface data management categories and user interface data management controls will be described in greater detail below. The user interface 400 further includes a preview display portion 406 for displaying a preview of the user interface components created or management by the software service.

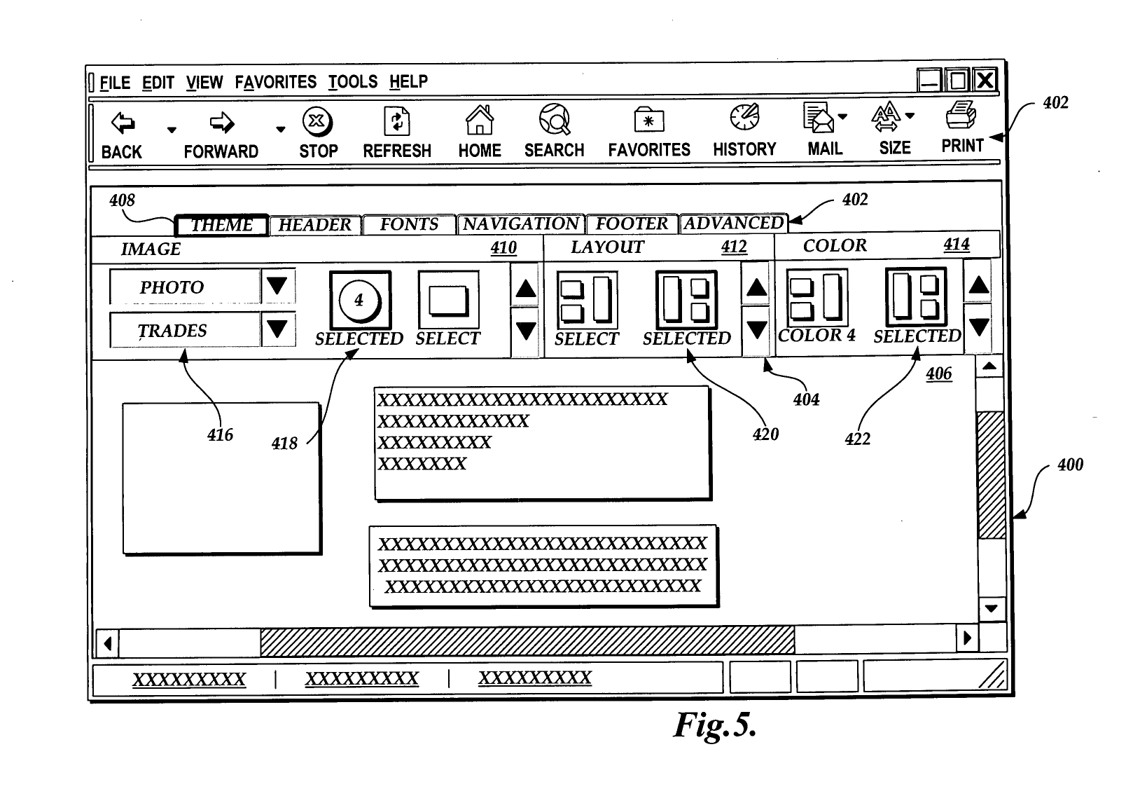

With reference now to FIG. 5, an illustrative user interface corresponding to a theme management user interface data management category will be described. In the illustrated example, the theme management user interface data management category tab 408 in the user interface data management categories 402 has been selected and highlighted on the user interface 400. In an illustrative embodiment, the tab 408 may be selected by manipulating mouse and/or keyboard controls.

Based upon the selection of the theme management user interface data management category tab 408, the user interface data management controls portion 404 is automatically generated to provide controls associated with the selected user interface data management category. Specifically, in the illustrative example, the controls are organized according to image selection controls 410, image layout controls 412, and theme color controls 412. The image selection controls 440 can include an image selection control 416 that facilitates the selection of various photos or images. As illustrated in FIG. 5, the photo selection control 416 includes a multi-level organizational menu that allows users to select photos or images according to various categories or image types. The image selection control also includes a set of image previews 418 that allows a user to select a specific image. The layout selection controls 412 include an image layout preview control 420. The image preview control 420 includes various selectable layouts for an image on the user interface. The theme control controls 414 include various selectable color schemas for an image and layout on the user interface.

In an illustrative embodiment, the application server 104 maintains a pre-computed set of image, layout and color combinations to provide an improved network user experience. In this embodiment, the images, layouts and colors are fixed and can be pre-computed. Alternatively, the user interface data management controls 404 can also include the ability for users to provide additional images, which would have to be processed by the application server 104 as it is received. In an illustrative embodiment, a different version of a selected image may be used dependent on the selected layout and selected color. For example, the application server 104 may maintain different versions of the same image for each potential layout and/or color.

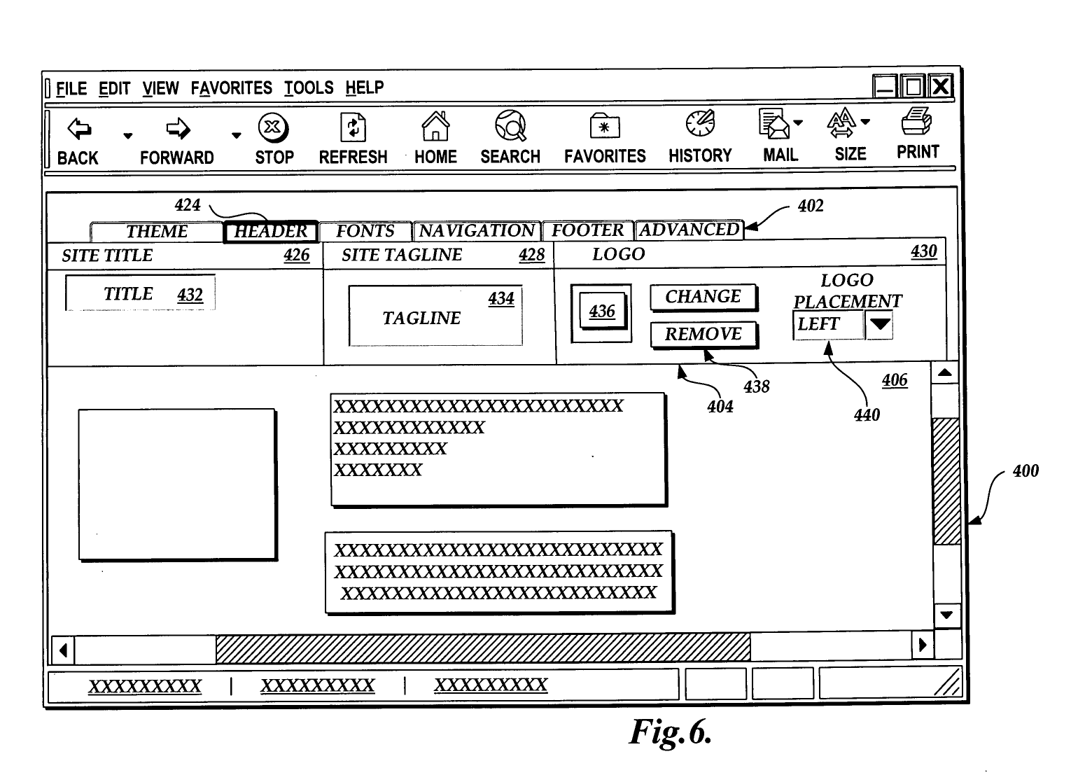

With reference now to FIG. 6, an illustrative user interface corresponding to a header management user interface data management category will be described. In the illustrated example, the header management user interface data management category tab 424 in the user interface data management categories 402 has been selected and highlighted on the user interface 400. In an illustrative embodiment, the tab 424 may be selected by manipulating mouse and/or keyboard controls.

Based upon the selection of the header management user interface data management category tab 424, the user interface data management controls portion 404 is automatically generated to provide controls associated with the selected user interface data management category. Specifically, in the illustrative example, the controls are organized according to site title controls 426, site tagline controls 428 and logo controls 430. The site title controls 426 include a text entry control 432 for obtaining user input of a textual title. The site tagline controls 428 can include a text entry control 434 for obtaining user input of a site tagline. The logo controls 430 can include a logo preview control 436, additional controls 438 for selecting a different logo image or removing a selected logo image, and a logo placement control 440.

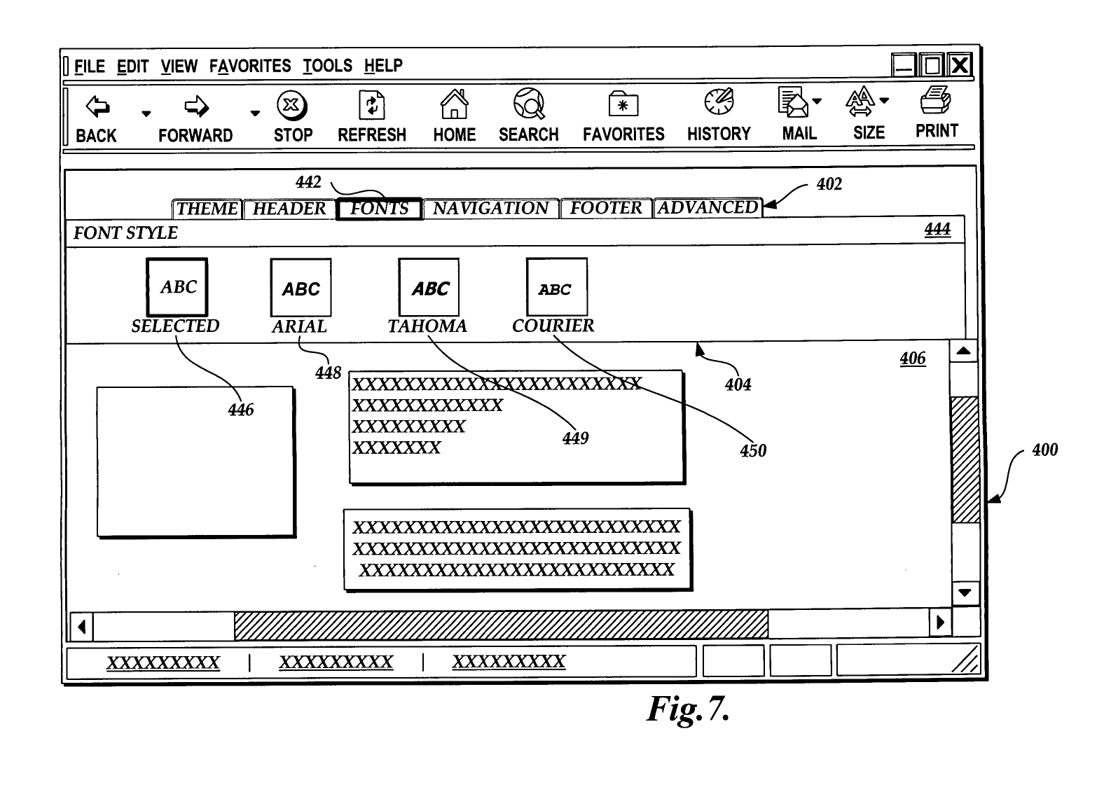

With reference now to FIG. 7, an illustrative user interface corresponding to a font style management user interface data management category will be described. In the illustrated example, the font style management user interface data management category tab 442 in the user interface data management categories 402 has been selected and highlighted on the user interface 400. In an illustrative embodiment, the tab 442 may be selected by manipulating mouse and/or keyboard controls.

Based upon the selection of the font style management user interface data management category tab 442, the user interface data management controls portion 404 is automatically generated to provide controls associated with the selected user interface data management category. Specifically, in the illustrative example, the controls are organized according to a font style control 444. The font style control 444 a set of selectable controls 446, 448, 449, 450 that illustrate a font style for all the text entries in the user interface. In an illustrative embodiment, the font styles can be hierarchically arranged to provide different fonts and formatting according to function. For example, a first level of text will be assigned a specific font and format while a second level of text will be assigned another specific font and format. As illustrated in FIG. 7, the selectable controls 446, 448, 449, 450 can include a preview of the corresponding font and/or formatting.

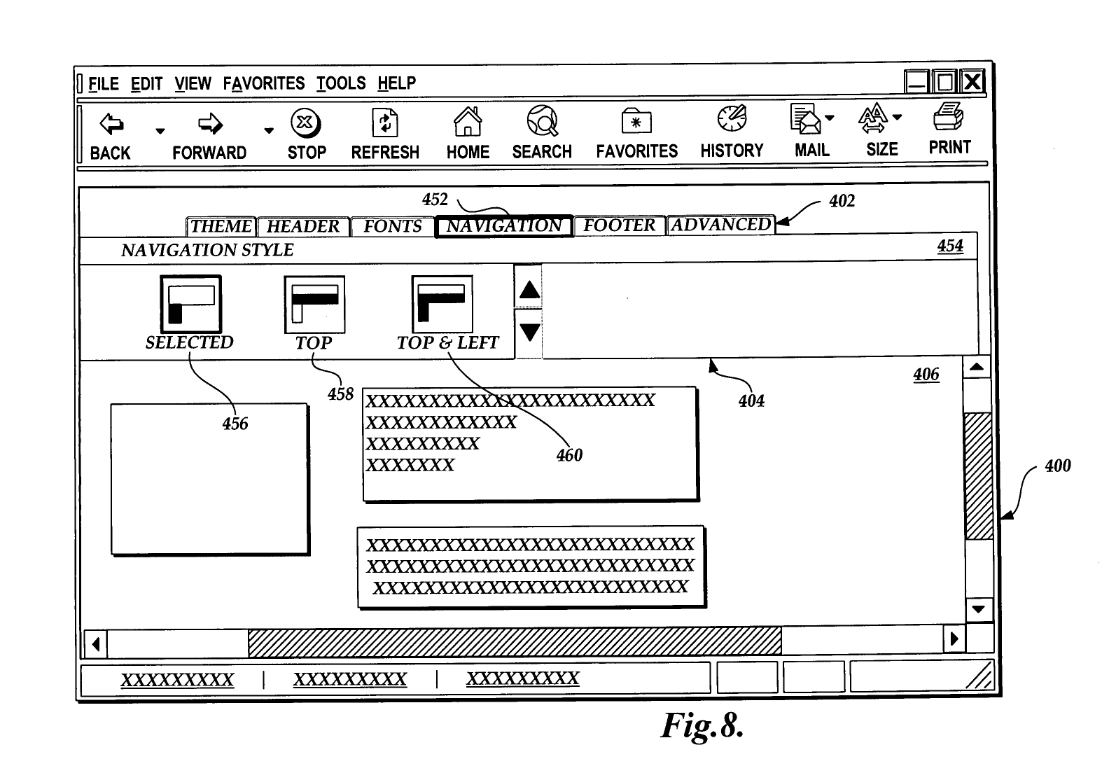

With reference now to FIG. 8, an illustrative user interface corresponding to a navigation style management user interface data management category will be described. In the illustrated example, the navigation style management user interface data management category tab 452 in the user interface data management categories 402 has been selected and highlighted on the user interface 400. In an illustrative embodiment, the tab 452 may be selected by manipulating mouse and/or keyboard controls.

Based upon the selection of the navigation style management user interface data management category tab 452, the user interface data management controls portion 404 is automatically generated to provide controls associated with the selected user interface data management category. Specifically, in the illustrative example, the controls are organized according to navigation style controls 454. The navigation style controls 454 include a set of selectable controls 456, 458, 460 that illustrate a layout style for the navigation links in the user interface. The controls 456, 458 and 460 can include a preview of the navigation style.

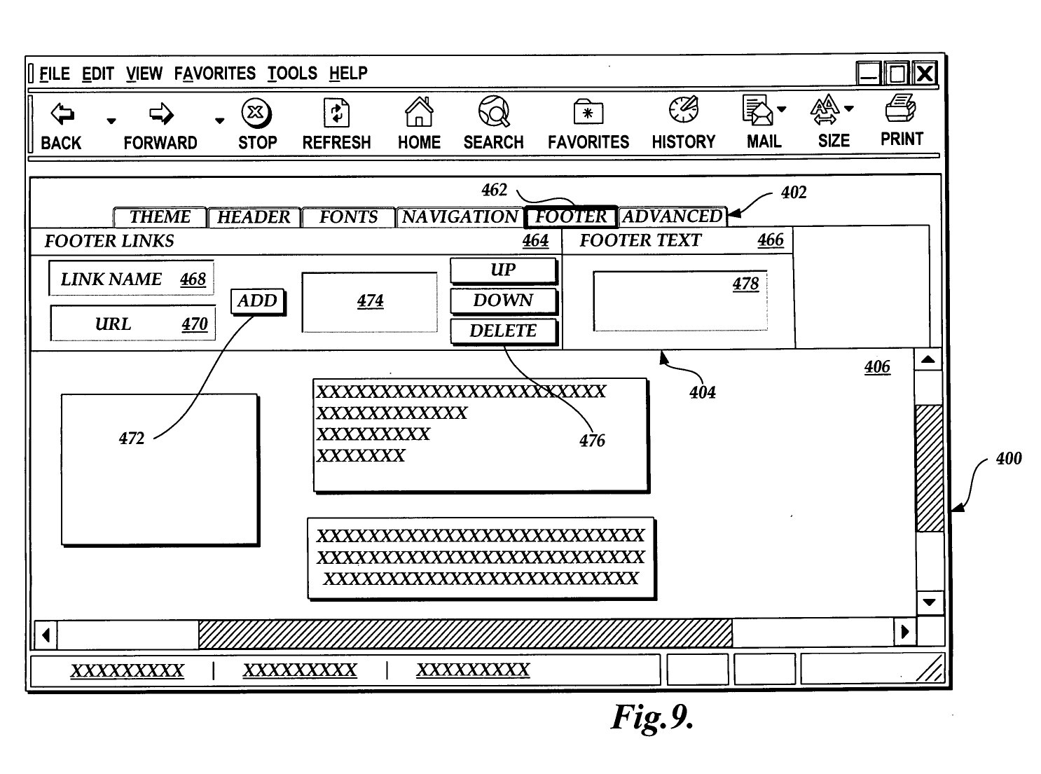

With reference now to FIG. 9, an illustrative user interface corresponding to a footer management user interface data management category will be described. In the illustrated example, the header management user interface data management category tab 462 in the user interface data management categories 402 has been selected and highlighted on the user interface 400. In an illustrative embodiment, the tab 462 may be selected by manipulating mouse and/or keyboard controls.

Based upon the selection of the footer management user interface data management category tab 462, the user interface data management controls portion 404 is automatically generated to provide controls associated with the selected user interface data management category. Specifically, in the illustrative example, the controls are organized according to footer links controls 464 and footer text controls 466. The footer links controls 464 can include text input controls 468 and 470 for identifying a link name to be displayed and a corresponding uniform resource location (URL) for the link. The footer links controls 464 can also include a control 472 to add a link to the user interface. The footer links controls 464 can also include a link preview control 474 for displaying the links that have been added to the user interface. Additionally, the footer links controls 464 can include various controls 476 for organizing the display of the added links. The footer text controls 466 can include a text entry control 478 for obtaining user input of a footer text.

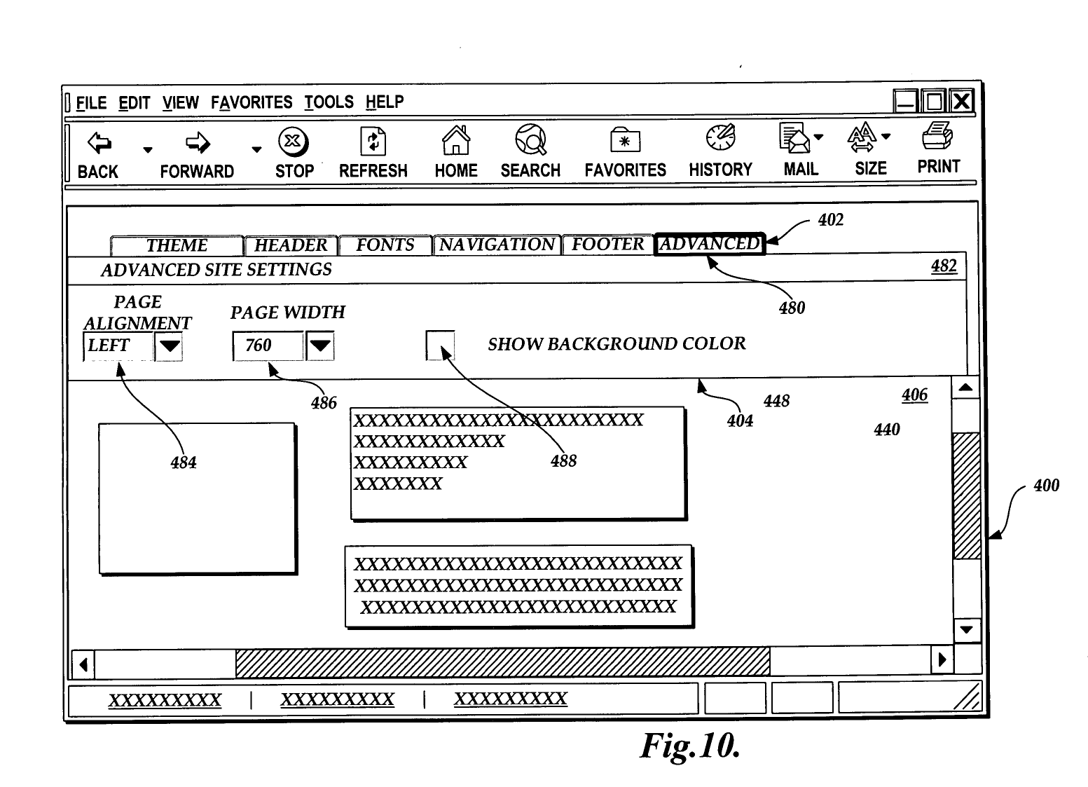

With reference now to FIG. 10, an illustrative user interface corresponding to an advanced management user interface data management category will be described. In the illustrated example, the advanced management user interface data management category tab 480 in the user interface data management categories 402 has been selected and highlighted on the user interface 400. In an illustrative embodiment, the tab 484 may be selected by manipulating mouse and/or keyboard controls.

Based upon the selection of the advanced management user interface data management category tab 480, the user interface data management controls portion 404 is automatically generated to provide controls associated with the selected user interface data management category. Specifically, in the illustrative example, the controls are organized according to advanced site settings controls 482. The advanced site setting controls 482 can include a page alignment control 484, a page width control 486, and a show background color control 488.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a communication network including at least one sending computing device and a receiving computing device, wherein the receiving computing device requests data from the sending computing device corresponding to a user interface creation software service and wherein the receiving computing device generates a user interface corresponding to the user interface creation software service on a display, a method for generating a user interface comprising:
generating in a first display portion of the user interface creation software service a display of a set of user interface data management categories, wherein at least one of the user interface data management categories corresponds to a theme associated with the user interface;
obtaining a selection of at least one user interface data management category; and
dynamically generating in a second display portion of the user interface creation software service a display of at least one control associated with the selected user interface data management category, wherein dynamically generating the at least one display control in the second display portion of the user interface creation includes displaying the at least one control associated with the selected user interface data management category as adjacent controls.

2. The method as recited in claim 1, wherein at least one of the set of user interface data management categories are selected from the group consisting of header management, font styles, navigation style, and footer management.

3. The method as recited in claim 2, wherein at least one control associated with the header management user interface data management category corresponds to a title entry control, a tagline entry control or a logo selection control.

4. The method as recited in claim 2, wherein at least one control associated with the font style user interface data management category corresponds to a font style selection control.

5. The method as recited in claim 2, wherein at least one control associated with the navigation style user interface data management category corresponds to a navigation layout control.

6. The method as recited in claim 2, wherein at least one control associated with the footer management user interface data management category corresponds to a link management control or a footer text entry control.

7. The method as recite in claim 1, wherein at least one control associated with the theme management user interface data management category corresponds to an image selection control, an image layout control or a theme color control.

8. The method as recited in claim 1, generating the set of user interface data management categories in a first display portion of the user interface creation software service includes generating a set of tabs corresponding to the set of user interface data management categories.

9. The method as recited in claim 1, wherein dynamically generating the at least one display control in the second display portion of the user interface creation software service includes displaying the at least one control associated with the selected user interface data management category in equally sized adjacent controls.

10. The method as recited in claim 1, wherein the first and second display portions are adjacent.

11. The method as recited in claim 1, wherein the user interface creation software service corresponds to a Web site user interface software service.

12. In a communication network including at least one sending computing device and a receiving computing device, wherein the receiving computing device requests data from the sending computing device corresponding to a user interface creation software service and wherein the receiving computing device generates a user interface corresponding to the user interface creation software service on a display, a computer-readable medium having computer-executable components for generating a user interface comprising:
a user interface data management category component for displaying a set of user interface data management categories including at least one user interface data management category corresponding to a theme associated with the user interface; and
a user interface control component associated with a selected user interface data management category and including at least one control associated with the selected user interface data management category.

13. The computer-readable medium as recited in claim 12, wherein at least one of the set of user interface data management categories are selected from the group consisting of header management, font styles, navigation style, and footer management.

14. The computer-readable medium as recited in claim 12, wherein the user interface data management category component is represented as a set of tabs and wherein the user interface control component is represented as a set of adjacent controls.

15. In a communication network including at least one sending computing device and a receiving computing device, wherein the receiving computing device requests data from the sending computing device corresponding to a user interface creation software service and wherein the receiving computing device generates a user interface corresponding to the user interface creation software service on a display, a method for generating a user interface comprising:
generating in a first display portion of the user interface creation software service a display of a set of user interface data management categories, wherein at least one of the user interface data management categories corresponds to a theme associated with the user interface;
obtaining a selection of at least one user interface data management category; and
dynamically generating in a second display portion of the user interface creation software service a display of at least one control associated with the selected user interface data management category, wherein dynamically generating the at least one display control in the second display portion of the user interface creation includes displaying the at least one control associated with the selected user interface data management category as adjacent controls;
obtaining a selection of a control in the second display portion of the user interface creation software service; and
modifying at least one user interface component based upon a selection of the control in the second display portion.

16. The method as recited in claim 15, wherein the control in the second display portion corresponds to a theme user interface data management category and wherein modifying at least one user interface component based upon a selection of the control in the second display portion includes modifying a theme associated with the at least one user interface component.

17. The method as recited in claim 15, wherein the control in the second display portion corresponds to a header management user interface data management category and wherein modifying at least one user interface component based upon a selection of the control in the second display portion includes modifying a header associated with the at least one user interface component.

18. The method as recited in claim 15, wherein the control in the second display portion corresponds to a footer user interface data management category and wherein modifying at least one user interface component based upon a selection of the control in the second display portion includes modifying a footer associated with the at least one user interface component.

19. The method as recited in claim 15, wherein the control in the second display portion corresponds to a font style user interface data management category and wherein modifying at least one user interface component based upon a selection of the control in the second display portion includes modifying a font style associated with the at least one user interface component.

20. The method as recited in claim 15, wherein the control in the second display portion corresponds to a navigation style user interface data management category and wherein modifying at least one user interface component based upon a selection of the control in the second display portion includes modifying a navigation style associated with the at least one user interface component.
